(19) United States
(12) Patent Application Publication
(10) Pub. No.: US 2026/0018825 A1
(43) Pub. Date: Jan. 15, 2026

(54) MANAGING WEIGHT DISTRIBUTION FOR A PLUG-IN COMPACT ELECTRONIC DEVICE

(71) Applicant: PLUME DESIGN, INC., Palo Alto, CA (US)

(72) Inventors: Ming-Tsung SU, Taipei City (TW); Yu-Han LIU, Taipei City (TW)

(21) Appl. No.: 18/769,755

(22) Filed: Jul. 11, 2024

(51) Int. Cl. H01R 13/516; H01R 31/06

(52) U.S. Cl. CPC H01R 13/516; H01R 31/06

(57) ABSTRACT

The present disclosure is directed to a stabilizing adaptor configured to enhance the stability and durability of a Type C plug when inserted into a Type E socket. The stabilizing adaptor includes a housing aperture configured to surround and engage a plug housing on multiple sides, preventing bending and/or pulling of the plug prongs out of the Type E socket due to the weight of an electronic device that includes a Type C plug. The stabilizing adaptor features engagement protrusions that cooperate with flexible engagement tabs to ensure a secure fit against a plug housing. A ground pin aperture accommodates the ground pin of a Type E socket, and a contour of an outer wall of the stabilizing adaptor engage the walls of a socket void, ensuring a stable and reliable connection for heavier electronic devices.

### FIELD OF THE DISCLOSURE

The present disclosure generally relates to a structural support for a plug-in electronic device. More particularly, the present disclosure relates to a system and methods for supporting a Type-C plug within a European Union (EU) Type-E socket outlet.

### BACKGROUND

Wi-Fi networks, also known as Wireless Local Area Networks (WLAN), are now prevalent in almost all settings. People use them at home, at work, and in public places like schools, cafes, and parks. Wi-Fi offers great convenience by eliminating cables and allowing for mobility. The range of applications using Wi-Fi keeps expanding, with examples including video streaming, audio streaming, phone calls, video conferencing, online gaming, and security camera feeds. Additionally, traditional data services such as web browsing, file transfers, disk backups, and numerous mobile apps are often used simultaneously.

### SUMMARY OF THE DISCLOSURE

Wi-Fi has become the primary means of connecting user devices to the Internet in homes and other locations, with the majority of connected devices relying on Wi-Fi for network access. Consequently, Wi-Fi access devices, specifically Wi-Fi Access Points (APs), are installed in a distributed manner within a location such as a home or office. The trend in consumer electronics design favors aesthetically pleasing, compact hardware. For example, a distributed Wi-Fi system comprises several Wi-Fi APs placed throughout a location like a residence. However, distributing multiple APs around a house necessitates that the weight of these devices are able to be supported by the electrical outlet.

A USB Type C connector for power may be required to utilize these distributed APs in some countries. Advantages of the USB Type C plug include its reversible nature, ease of use. However, a significant issue encountered is the stability of the connection when a heavy device with a USB Type-C plug is inserted into a Type E outlet. The Type E socket often fails to provide sufficient support to securely hold heavier devices that use a Type C plug. This results in the device or the adaptor partially or completely falling out of the outlet, leading to frequent disconnections and a general inconvenience for the user. The bending moment caused by the heavier device may also cause the prongs of the plug to bend, damaging the device.

Therefore, there is a need for a more secure and stable solution to ensure that devices with USB Type C plugs can be stably attached to Type E outlets.

In some embodiments, the disclosed system includes a compact electronic device that functions as a wireless Access Point (AP). In some embodiments, the AP includes a housing with multiple sides adjacent to a base portion. The base houses various components including a fan module, a Printed Circuit Board (PCB) with one or more Wi-Fi radios, and/or a power supply. The AP also features an electrical plug connected to the power supply, extending from the bottom for insertion into an electrical outlet, providing both power and physical support for the AP. In some embodiments, the AP includes multiple vents hidden from view when the device is plugged into the outlet.

In some embodiments, the AP features an outer plastic housing and an inner casing which contains components that support both higher and lower voltage operations within a single structure. In some embodiments, the system includes a single fan designed to draw air from outside the housing and expel it through exhaust vents in the housing. In some embodiments, the power supply is electrically connected to a Type C electrical plug extending from a base portion of the housing.

In some embodiments, the housing comprises a continuous gap that is configured as both an air intake and an air exhaust. In some embodiments, the housing comprises a removable top cover attached to a base, forming slit vents with a predetermined gap that allow air to flow into the housing. The top cover is configured to couple to the base, and the top cover and the base surround the inner casing.

In some embodiments, the gap between the top cover and the base include multiple intake air vents and at least one exhaust air vent, with a bottom section of the AP featuring one or more additional intake vents. An additional exhaust vent under the air gap exhaust vent increases airflow out of the AP.

In some embodiments, the system includes a stabilizing adaptor configured to enhance the stability and durability of a Type C plug when inserted into a Type E socket. The stabilizing adaptor is configured to counter the bending force that results from the weight of the electronic device, preventing bending of the plug prongs and/or the plug housing and/or preventing the weight of the device from pulling the plug from the socket. The stabilizing adaptor may be provided as part of a kit that includes one or more stabilizing adaptors and/or electronic devices equipped with Type C adaptor plugs.

In some embodiments, the stabilizing adaptor includes a housing aperture configured to surround and engage a plug housing on multiple sides, providing robust support. The housing aperture walls include engagement slots that form flexible engagement tabs, which can flex away from the housing aperture to accommodate insertion and removal of a plug without causing plastic deformation. The engagement tabs may also include protrusions to enhance the grip on the plug housing, ensuring a secure fit.

In some embodiments, the stabilizing adaptor includes a ground pin aperture configured to accommodate the ground pin of a Type E socket. The outer wall of the stabilizing adaptor is configured to follow the contour of a Type E socket, with one or more flat portions along the outer wall to facilitate removal from a socket void. In some embodiments, the adaptor's shape ensures that the adaptor engages with the plug housing securely, preventing motion in all directions parallel to a plug base face, enhancing the stability and reliability of the connection between an electronic device Type C plug and a Type E socket.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 shows a simplified diagram of an electronic device configured to be plugged into an electrical outlet according to some embodiments of the present disclosure;

FIG. 2 illustrates a perspective view of the electronic device according to some embodiments of the present disclosure;

FIG. 3 shows how the weight of the electronic device and the gap between the plug base and socket face causes a bending stress when plugged in according to some embodiments of the present disclosure;

FIG. 4 depicts a stabilizing adaptor inserted between the electronic device and Type E socket according to some embodiments of the present disclosure;

FIG. 5 shows a perspective view of the stabilizing adaptor according to some embodiments of the present disclosure;

FIG. 6 illustrates details of a void side of the stabilizing adaptor according to some embodiments of the present disclosure;

FIG. 7 shows details of the stabilizing adaptor outer wall according to some embodiments of the present disclosure;

FIG. 8 shows the stabilizing adaptor coupled to a Type C plug housing according to some embodiments of the present disclosure;

FIG. 9 illustrates a perspective view of the stabilizing adaptor coupled to a Type C plug housing according to some embodiments of the present disclosure;

FIG. 10 shows details of a Type E socket according to some embodiments of the present disclosure; and

FIG. 11 shows the stabilizing adaptor inserted into the Type E socket according to some embodiments of the present disclosure.

### DETAILED DESCRIPTION

The disclosure is directed to a system and methods for supporting electronic devices with a Type C plug when inserted into a Type E socket and/or outlet. In some embodiments, these devices include Wi-Fi Access Points (APs) in distributed Wi-Fi systems, which feature a small form factor with multiple sides, direct plug-in capability to an electrical outlet, and internal components such as a power supply and fan. In some embodiments, the electronic device includes a unique form factor and an air gap that utilizes the same openings for both intake and exhaust.

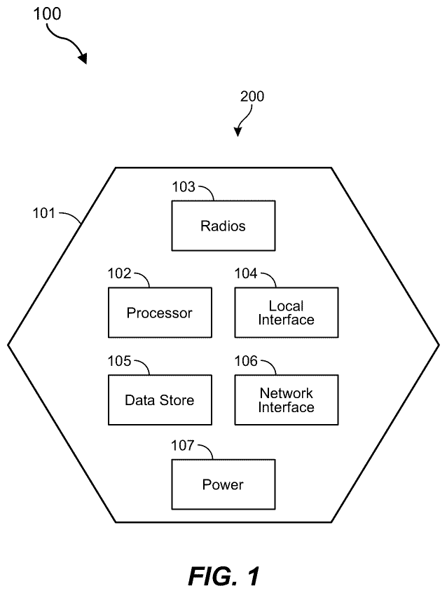

Referring to the figures, various illustrations depict a compact electronic device 100 for illustration purposes. In some embodiments, this device functions as a wireless Access Point (AP) 200 or equivalent wireless access device. As shown in FIG. 1 the AP 200 features a compact form factor 101 that allows it to be plugged directly into a Type E electrical socket 301. While described herein as a wireless access point 200, it is understood that the systems and methods described here can be applied to any type of electronic device, including sensors, cameras, and Internet of Things (IoT) devices, as non-limiting examples.

In some embodiments, the size of the AP is compact, meaning the AP is configured to not obstruct other outlets, and/or is weighted to be supported by an electrical outlet. In some embodiments, the AP 200, which includes a Type C plug 203 in this example, is weighted to be supported by a Type C outlet (not shown).

With reference to FIG. 1, in some embodiments, the physical form factor 101 includes a processor 102, multiple radios 103, a local interface 104, a data store 105, a network interface 106, and/or a power supply 107. The diagram shown in FIG. 1 simplifies the compact electronic device 100, and some embodiments may have additional components and processing logic to support the described features or conventional operating features not detailed here.

In some embodiments, the form factor 101 is ideal for distributing many access points throughout a residence. The processor 102 executes software instructions and can be a custom or commercially available CPU, a semiconductor-based microprocessor, a chipset, and/or any device for executing software instructions. When operational, the processor 102 executes software stored in memory or the data store 105, communicates data to and from these storage elements, and generally controls the access point's operations. The processor 102 may be optimized for power consumption and mobile applications.

In some embodiments, the radios 103 enable wireless communication, operating according to the IEEE 802.11 standard, for example, and includes connections for communications on a Wi-Fi system. The access point 200 can support multiple radios for different links, such as backhaul and client links. Some embodiments support dual-band operation with 2.4 GHz and 5 GHz 2×2 MIMO 802.11b/g/n/ac radios, providing operating bandwidths of 20/40 MHz for 2.4 GHz and 20/40/80 MHz for 5 GHz. The APs 200 may also support IEEE 802.11AC1200 gigabit Wi-Fi.

The local interface 106 enables local communication with the access point 200, either wired or wirelessly (e.g., Bluetooth®). The data store 105 stores data and may include volatile memory (e.g., RAM), nonvolatile memory (e.g., ROM, hard drive, CDROM), or combinations thereof, incorporating various types of storage media.

The network interface 106 provides wired connectivity, such as the RJ-45 ports 205, enabling communication with a modem/router and local connectivity to Wi-Fi client devices. This can provide network access to devices without Wi-Fi support. The network interface 106 may further include an Ethernet card or adaptor, with connections for appropriate network communications. The processor 102 and the data store 106 include software and/or firmware controlling the access point's operation, data management, and/or memory management according to some embodiments.

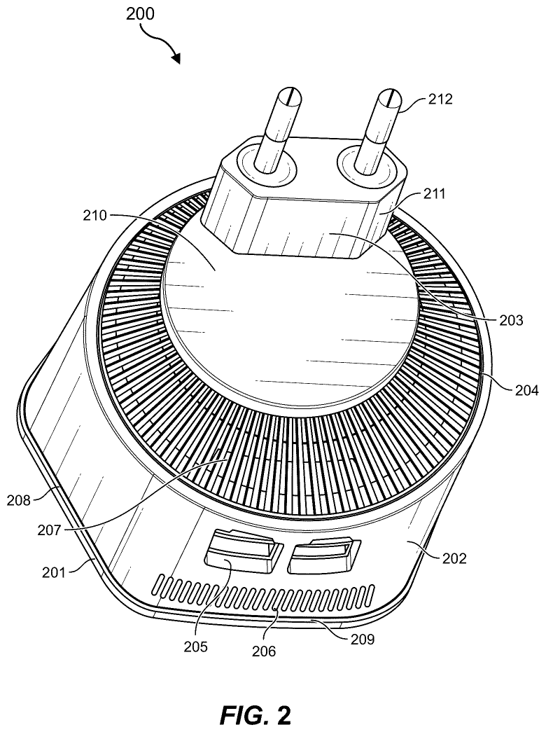

As shown in FIG. 2, the AP 200 includes a top cover 201 over a base 202 and a Type C electrical plug 203 protruding from a plug base 210 located at the bottom portion 204 of the base 202. In some embodiments, the base 202 includes RJ-45 ports 205 for data connectivity, such as via Ethernet cables. The base 202 may also include other types of wired ports, which are not illustrated. Additionally, the base 202 features various openings for air intake and exhaust, including an exhaust vent(s) 206 on a side of the base 202, an intake vent(s) 207 on the bottom portion 204, and an air gap 208 between the top cover 201 and the base 202.

In some embodiments, the exhaust vent 206 and intake vent 207) are configured to be hidden when the compact electronic device 100 is plugged into an electrical outlet. Multiple openings for air intake, including intake vent 207 and air gap 208, allow cooler air to reach the components near the respective vents.

The electrical plug 203 serves dual functions: providing electrical connectivity to a corresponding outlet and mechanically supporting the compact electronic device 100 while it is plugged in. In some embodiments, the bottom portion 204 is configured to face an electrical outlet. In some embodiments, the intake vent 207 is separated from the bottom portion 204 by the plug base 210 to create an airflow spacing when a plug base 210 is in contact with the face of a Type C socket.

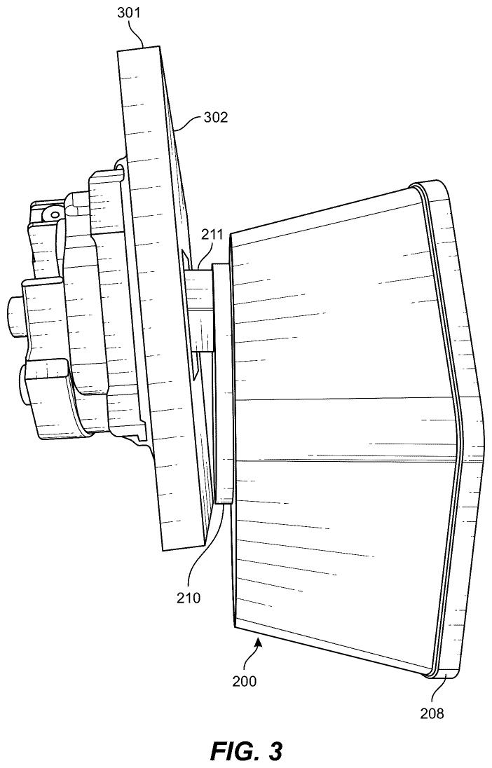

Referring now to FIG. 3, when the Type C plug 203 is inserted into a Type E socket 301, the plug housing 211, which encases at least a portion of the plug prongs 212, prevents the plug base 210 from being substantially flush (e.g., less than 2 mm gap when plugged in) with the socket face 302. As shown in FIG. 3, the weight of AP 200 causes the plug prongs 212 and/or the plug housing 211 to bend, leading to potential damage.

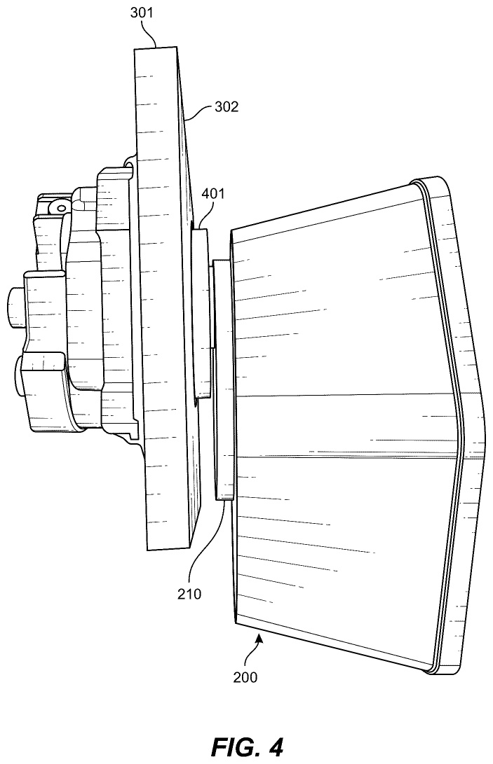

FIG. 4 shows an assembled view of the system, which includes one or more of a Type E socket 301, a stabilizing adaptor 401, an electronic device (e.g., AP 200), as well as any associated components. In some embodiments, the stabilizing adaptor 401 is configured to limit bending of the Type C plug prongs 212 and/or the plug housing 211 when the AP 200 is plugged into a Type E socket 301. While AP 200 is compact, bending forces are still generated due to the eccentric loading of the cantilever arrangement.

In some embodiments, the stabilizing adaptor 401 is configured to counter a bending force on plug prongs 212 and/or the plug housing 211 resulting from the weight of the AP 200 when the AP 200 is plugged into a Type E socket 301. The stabilizing adaptor 401, according to some embodiments, is configured to counter a bending force on plug prongs 212 and/or the plug housing 211 such that the plug base 210 remains substantially parallel (i.e., less than 3° angle) with the socket face 302. In some embodiments, the system includes a kit that includes one or more stabilizing adaptors 401 and one or more electronic devices (e.g., AP 200) that include a Type C adaptor plug.

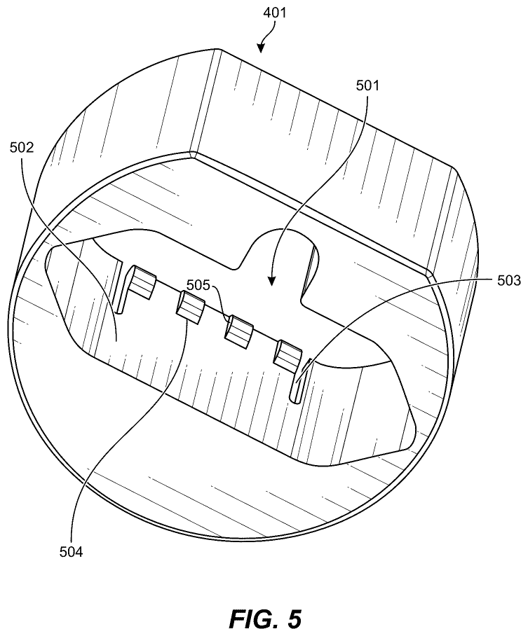

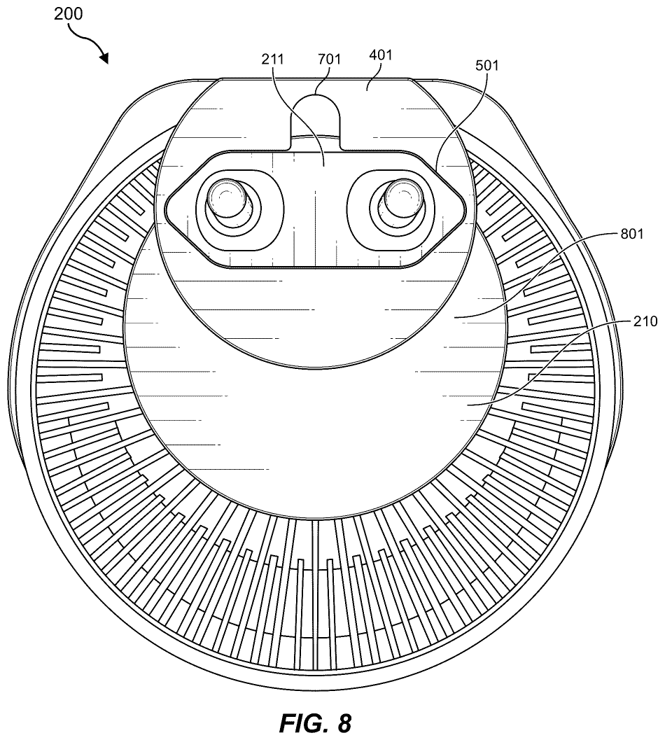

As shown in FIG. 5, the stabilizing adaptor 401 includes a housing aperture 501 configured to surround, engage, and/or contact the plug housing 211 on at least 3 sides, with 6 sides being contacted by aperture walls 501 in the non-limiting example shown in FIG. 8. In some embodiments, the housing aperture 501 includes a hexagonal shape, and is configured to conform to a Type C plug housing 211. In some embodiments, one or more wall include one or more engagement slots 503 configured to form an engagement tab 504, where the engagement tab 504 is configured to enable at least a portion of an aperture wall 502 to flex away from one or more other aperture walls. In some embodiments, the engagement tab 504 includes one or more engagement protrusions 505 configured to force the engagement tab 504 away from a plug housing 211 when the system is assembled. The material chosen for the stabilizing adaptor can be any material with a modulus of elasticity that enables the engagement tab 504 to flex away from the housing aperture 501 multiple times (e.g., 50 times) without plastic deformation of the engagement tab 504.

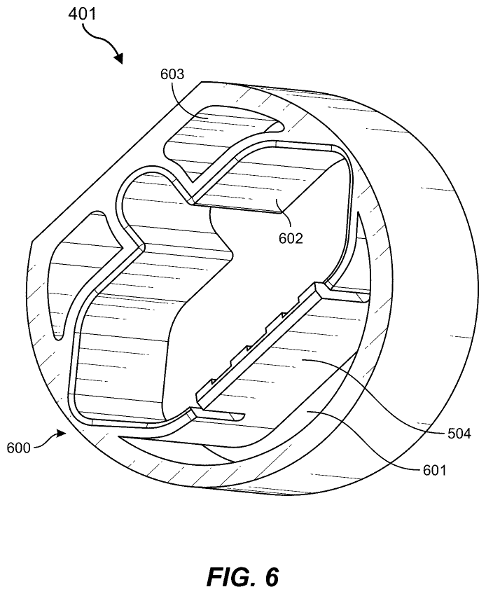

FIG. 6 shows a void side 600 of the stabilizing adaptor 401 according to some embodiments. In some embodiments, the stabilizing adaptor 401 includes a tab void 601 positioned beneath each of the one or more engagement tabs 504, which provides room for an engagement tab 504 to flex. While shown with a single engagement tab 504 in this non-limiting example, the stabilizing adaptor can include additional engagement tabs 602 (represented by dashed lines) and/or additional tab voids 603.

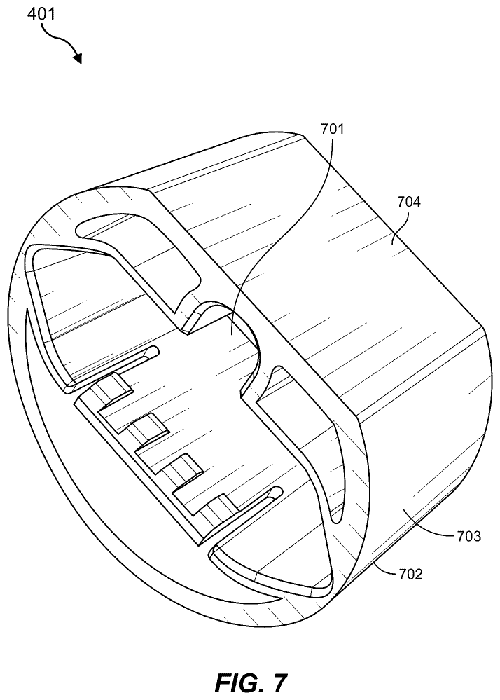

As illustrated in FIG. 7, the stabilizing adaptor 401 may include a ground pin aperture 601, in accordance with some embodiments. Best shown in FIG. 11, in some embodiments, the ground pin aperture 701 is configured to enable the ground pin 1001 of a Type E socket 301 to pass through the stabilizing adaptor 401. In some embodiments, the ground pin aperture 701 is configured not to contact a ground pin 1001. In some embodiments, the ground pin aperture 701 is configured to engage and/or contact a ground pin 1001 for additional support and/or grip on the Type E socket 301.

In some embodiments, the stabilizing adaptor includes an outer wall 702, where a majority of the outer wall 702 includes a curved surface 703 configured to follow the contour of a Type E socket 1002. In some embodiments, the outer wall 702 includes at least one flat portion 704 configured to recess the outer wall 702 from the socket wall 1002. In some embodiments, at least a portion of the outer wall 702 is configured to engage with the socket wall 1002: the flat portion 704 aids in the removal of the stabilizing adaptor 401 from within a Type E socket void 1003.

FIG. 8 depicts the plug housing 211 of AP 200 inserted through the housing aperture 501 in accordance with some embodiments. As mentioned previously, the housing aperture 501 is configured to surround, engage, and/or contact the plug housing 211 on at least 3 sides, with 6 sides being contacted by aperture walls 502 in this non-limiting example. In some embodiments, the housing aperture 501 includes a substantially same shape as the plug housing 211, such that motion of the aperture wall 502 is prevented in all directions parallel to the plug base face 801, where the ground pin aperture 701 is the only portion not conforming to the shape of the plug housing 211.

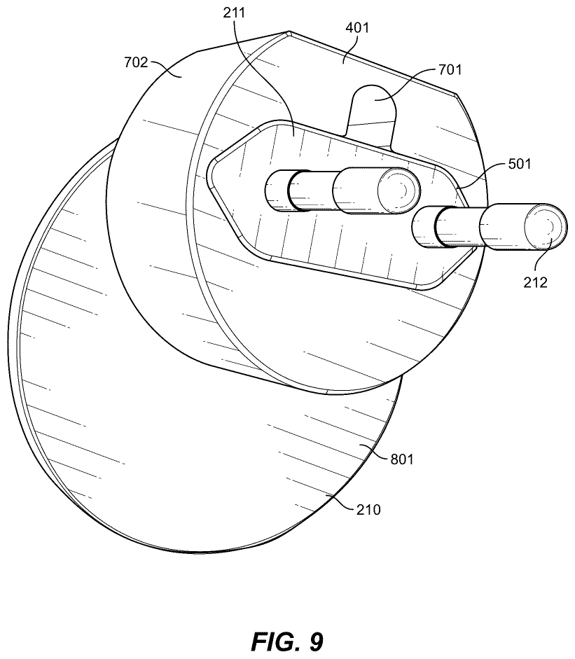

Turning now to FIG. 9, in some embodiments, at least 50% of an area of the void side 600, defined by the outer wall 702, is configured to engage with the base face 801 when the stabilizing adaptor is coupled to the plug housing 211. In some embodiments, the housing aperture 501 includes the ground pin aperture 701. In some embodiments, a width of the ground pin aperture 701 and/or stabilizing adaptor 401, measured perpendicular from the void side 600, is greater than or equal to the length of the ground pin 1001 of an EU Type E socket 301. In some embodiments, a width of the stabilizing adaptor 401, measured perpendicular from the void side 600, is substantially (±2 mm) the width of a plug housing 211. In some embodiments, a width of the outer wall 702 is greater than or equal to the depth of a Type E socket void 1003.

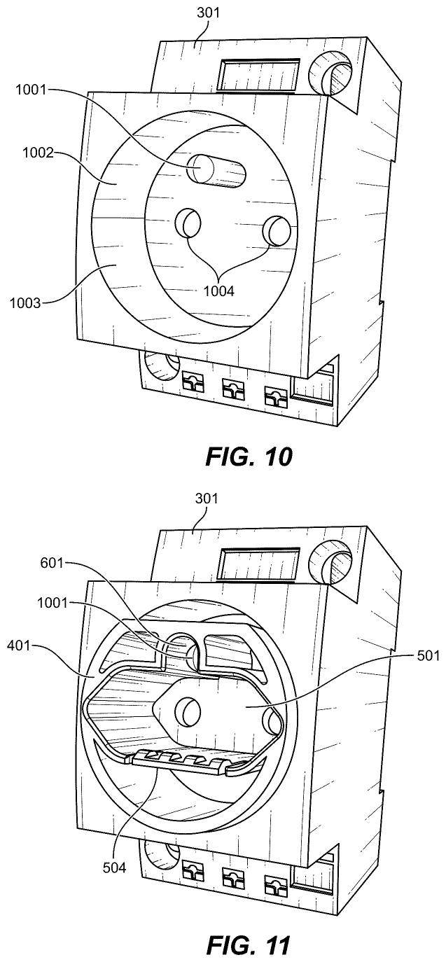

FIG. 10 shows details of a Type E socket in accordance with some embodiments. In some embodiments, in addition to the ground pin 1001, the Type E socket includes two plug receptacles 1004 configured to enable both plug prongs 212 to pass therethrough. FIG. 11 depicts the stabilizing adaptor 401 inserted into the socket void 1003 in accordance with some embodiments. As shown in FIG. 11, the ground pin 1001 does not extend past an end of the void side 600 of the stabilizing adaptor 401, and the two plug receptacles 1004 are accessible through the housing aperture 501. In some embodiments, the stabilizing adaptor is symmetric and/or reversible, such that one or more engagement tabs 504 can engage with the plug housing 211 at a location proximal or distal from the base face 801, depending on whether the void side 600 is oriented toward or away from the plug base 210.

While the Type C plug described herein is shown attached to an AP 200, it is understood that the system is not limited in its application to the details of construction and the arrangement of components set forth in the previous description or illustrated in the drawings. The system and methods of assembly disclosed herein fall within the scope of numerous embodiments. The previous discussion is presented to enable a person skilled in the art to make and use embodiments of the system with any electronic device that uses a Type C plug. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable into a description of the metes and bounds of the system. Any structures shown or described in the drawings are to be considered as the system comprising the structures. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured unless otherwise stated (e.g., degrees, volume, mass, distance).

As used herein, “can” or “may” or derivations thereof are used for descriptive purposes only and is understood to be synonymous and/or interchangeable with “configured to” when defining the metes and bounds of the system.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

It will be appreciated by those skilled in the art that while the system has been described above in connection with some embodiments and examples, the system is not necessarily so limited, and that numerous other embodiments, examples, uses, modifications and departures from the embodiments, examples and uses are intended to be encompassed by the claims attached hereto. Various features and advantages of the system are set forth in the following claims.

What is claimed is:

1. A stabilizing adaptor comprising:
an outer wall,
a housing aperture, and
a ground pin aperture;
wherein the housing aperture is configured to surround a plug housing of a Type C plug;
wherein the ground pin aperture is configured to enable a ground pin of a Type E socket to pass through; and
wherein the outer wall is configured to enable the stabilizing adaptor to fit inside a socket void of the Type E socket while the ground pin of the Type E socket passes through the ground pin aperture.

2. The stabilizing adaptor of claim 1, wherein the ground pin aperture is formed as part of the housing aperture.

3. The stabilizing adaptor of claim 1, wherein the outer wall includes at least one flat portion.

4. The stabilizing adaptor of claim 3, wherein the flat portion is configured to recess the outer wall from a socket wall of the socket void.

5. The stabilizing adaptor of claim 4, wherein at least a portion of the outer wall is configured to engage the socket wall.

6. The stabilizing adaptor of claim 1, further comprising an engagement tab.

7. The stabilizing adaptor of claim 6, wherein the engagement tab is formed by two or more slots within one or more aperture walls of the housing aperture.

8. The stabilizing adaptor of claim 7, wherein the engagement tab comprises one or more engagement protrusions.

9. The stabilizing adaptor of claim 8, wherein the stabilizing adaptor comprises a tab void.

10. The stabilizing adaptor of claim 9, wherein the one or more engagement protrusions are configured to cause the engagement tab to flex into the tab void when the plug housing is inserted into the housing aperture.

11. The stabilizing adaptor of claim 1, wherein the stabilizing adaptor is reversible.

12. The stabilizing adaptor of claim 1, wherein the housing aperture includes a substantially same shape as the plug housing on at least 3 sides.

13. The stabilizing adaptor of claim 1, wherein the housing aperture is configured to engage the plug housing in a manner to prevent lateral movement of the stabilizing adaptor.

14. The stabilizing adaptor of claim 1, wherein a width of the ground pin aperture is greater than or equal to the length of the ground pin of the Type E socket.

15. The stabilizing adaptor of claim 1, wherein a width of the outer wall is greater than or equal to the depth of a Type E socket void.
